(19) United States
(12) Patent Application Publication
(10) Pub. No.: US 2007/0154767 A1
(43) Pub. Date: Jul. 5, 2007

(54) Fuel cartridge for fuel cell and fuel cell using the same

(75) Inventors: Hidekazu Kimura, Minato-ku (JP); Takashi Manako, Minato-ku (JP); Hiroshi Kajitani, Minato-ku (JP); Tsutomu Yoshitake, Minato-ku (JP); Satoshi Nagao, Minato-ku (JP); Eiji Akiyama, Minato-ku (JP); Yasutaka Kouno, Minato-ku (JP); Hideyuki Sato, Minato-ku (JP); Suguru Watanabe, Minato-ku (JP); Takanori Nishi, Minato-ku (JP); Yoshinori Watanabe, Mianto-ku (JP); Yoshimi Kubo, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, TOKYO (JP)

(21) Appl. No.: 10/586,850

(22) PCT Filed: Jan. 20, 2005
(86) PCT No.: PCT/JP05/00678

§ 371 Date: Jul. 20, 2006

(30) Foreign Application Priority Data
Jan. 23, 2004 (JP) 2004-016393

(51) Int. Cl. H01M 8/04; B65D 35/56; B67D 5/00

(52) U.S. Cl. 429/34; 222/105; 222/81

(57) ABSTRACT

Fuel cartridge 1501 has a double structure including case 1502 and inner container 1503 stored with liquid fuel 124. Case 1502 is made of a resin that is impact-resistant. Inner container 1503 is made of a resin resistant to liquid fuel.

### TECHNICAL FIELD

The present invention relates to a fuel cartridge for a fuel cell and a fuel cell using the same.

### BACKGROUND ART

A solid electrolyte type fuel cell includes a fuel electrode and an oxidizer electrode and a solid electrolyte film arranged therebetween. When fuel is supplied to the fuel electrode and an oxidizer is supplied to the oxidizer electrode, electricity is generated by an electrochemical reaction. The fuel electrode and the oxidizer electrode each include a base and a catalytic layer arranged on the surfaces of the base. Hydrogen is generally used as the fuel. However, in recent years, fuel cells using inexpensive and easy-to-handle methanol as a material have been actively developed. For example, there is a methanol reforming fuel cell in which methanol is reformed to generate hydrogen and hydrogen is used as fuel and there is a direct fuel cell that directly uses methanol as fuel.

When methanol is directly used as fuel, the reaction at the fuel electrode is represented by the following equation (1).
CH3OH +H2O →6H++CO2 +6e− (1)

Also, the reaction at the oxidizer electrode is represented by the following equation (2).
3/2O2 +6H++6e−→3H2O (2)

In this way, in the direct fuel cell, because hydrogen ion can be obtained from a methanol solution, a device, like a fuel reformer, is not required and size reduction and weight reduction can be attained. Also, since a methanol solution in liquid is used as fuel, the direct fuel cell has the advantage that energy density is extremely high.

Japanese Patent Laid-Open No. 2003-92128 discloses a fuel cartridge for supplying fuel to a fuel cell, which is used as a power source for a portable electronic device. In this way, there have been proposed fuel cartridges that are attachable and detachable to/from the fuel cell. However, in the fuel cartridge disclosed in Japanese Patent Laid-Open No. 2003-92128, because the external wall is made of polyethylene, polypropylene, or the like, impact-resistance characteristics of the fuel cartridge can be improved. Since the fuel cartridge is carried by a user of the fuel cell, there is a possibility that the user may drop the fuel cartridge. Therefore, it is important to improve the impact-resistance of the fuel cartridge in order to gain acceptance of fuel cells by the public. The fuel cartridge stored with organic liquid fuel, like methanol, is required to be resistant to organic liquid fuel.

Patent Document 1: Japanese Patent Laid-open No. 2003-92128 Disclosure of Invention

The present invention is intended to address the above situation and has its object to provide a technique for improving the impact-resistance and the resistance to organic liquid fuel of the fuel cartridge.

The present invention provides a fuel cartridge for a fuel cell, that is stored with liquid fuel to be supplied to a fuel electrode in the fuel cell and is attachable and detachable to/from the fuel cell, characterized in that the fuel cartridge comprises a fuel storage chamber whose an inner surface is made of resin that is resistant to the liquid fuel, a case that contains the fuel storage chamber inside and that is made of impact-resistant resin, and a fuel supply part that is connected to the fuel storage chamber and that supplies the liquid fuel to the fuel cell. This fuel cartridge is attachable and detachable to/from the fuel cell, and is a compact resinous fuel container that can be carried by a user.

In the present invention, resin that is resistant to liquid fuel is resin that can resist being dissolved and resist deterioration when in contact with the liquid fuel and whose resistance characteristics are at least higher than the resin that forms the case. Also, the impact-resistant resin is a resin having resistance to impact from the outside and whose resistance is at least larger than the resin that forms the inner surface of the fuel storage chamber.

The inner surface of the fuel storage chamber may be made of alcohol-resistance resin. In this case, the liquid fuel may include alcohol components.

The fuel cartridge according to the present invention is provided with the case made of impact-resistant resin, and thus is excellent in resistance to impact from the outside. Also, since the fuel cartridge is provided with a fuel storage chamber that is contained in the case and that has the inner surface made of resin-resistant to the liquid fuel (for example, alcohol-resistant resin), dissolving and deterioration caused when the inner surface of the fuel storage chamber is in contact with the liquid fuel, like alcohol, can be reliably prevented. Therefore, the impact-resistance characteristics and the resistance in the fuel cartridge to the liquid fuel can be improved. Accordingly, the fuel cartridge can be used safely for a long period.

In the fuel cartridge for the fuel cell according to the present invention, the fuel storage chamber and the case are jointly integrated. Based on this arrangement, the fuel cartridge that is excellent in impact-resistance characteristics and resistance to the liquid fuel in a simple arrangement can be easily manufactured. Therefore, the fuel cartridge that is safe and is excellent in terms of stable manufacturing can be reliably supplied.

In the fuel cartridge for the fuel cell according to the present invention, the fuel storage chamber may be a bag-shaped member made of flexible material. Based on this arrangement, the volume of the fuel storage chamber can be varied easily in accordance with the volume of the fuel stored in the fuel storage chamber. Therefore, liquid fuel can be supplied to the fuel cell efficiently. Also, the mechanical strength of the fuel cartridge can be improved still further.

In the fuel cartridge for the fuel cell according to the present invention, a cushioning member may be arranged between the fuel storage chamber and the case. According to this arrangement, the impact from the outside can be absorbed by the cushioning member and the load caused by the impact from the outside can be dispersed. Therefore, the impact-resistance of the fuel cartridge can be improved still further. In the fuel cartridge for the fuel cell, the cushioning member may be one material or two or more materials among natural rubber, isoprene rubber, butadiene rubber, styrene-butadiene rubber, chloroprene rubber, acrylonitrilebutadiene rubber, silicone rubber, butyl rubber, urethane rubber, ethylene propylene rubber, ethylene-vinyl acetate copolymer, foamed polyurethane, silicone gel, and styrene gel. According to this arrangement, the impact-resistance of the fuel cartridge can be further improved with reliability.

The fuel cartridge for the fuel cell according to the present invention may include a pressure adjustment member for adjusting the inner pressure of the fuel storage chamber. According to this arrangement, the liquid fuel stored in the fuel storage chamber can be stably supplied from the fuel supply part to the fuel cell. In the fuel cartridge for the fuel cell, the pressure adjustment member may include a gas-liquid separation film. According to this arrangement, the liquid fuel can be prevented from leaking to the outside of the fuel cartridge while the inner pressure in the fuel supply chamber is reliably adjusted. Therefore, the safety of the fuel cartridge in use can be improved still further.

The fuel cartridge for the fuel cell according to the present invention may includes a vent through the case. According to this arrangement, when the liquid fuel stored in the fuel storage chamber is consumed, outside air can be reliably introduced into the case. Therefore, the inner pressure in the fuel supply chamber can be adjusted with further reliability.

Also, the present invention provides a fuel cell characterized in that the fuel cell includes a fuel cell main body having a fuel electrode and a fuel cartridge for the fuel cell according to any one of above-mentioned arrangements, which is stored with liquid fuel to be directly supplied to the fuel electrode.

The fuel cell according to the present invention has a fuel cartridge with excellent impact-resistance and excellent resistance to the liquid fuel (for example, methanol-resistance). Therefore, the safety in use can be improved.

Incidentally, any combination of each element, various apparatuses using the fuel cartridge for fuel cell or the fuel cell, and methods of manufacturing and using these are also available as aspects of the present invention.

For example, according to the present invention, a fuel cartridge for a fuel cell, that is stored with liquid fuel to be supplied to a fuel electrode in the fuel cell and attachable and detachable to/from the fuel cell, is characterized in that the fuel cartridge includes a fuel storage chamber whose inner surface is made of a first resin material, includes a case that contains the fuel storage chamber inside and that is made of a second resin material, and a fuel supply part that is connected to the fuel storage chamber and that supplies the liquid fuel to the fuel cell, the first resin material is superior to the second resin material in the resistance to the liquid fuel, and the second resin material is superior to the first resin material in the impact-resistance. According to this arrangement, both the impact-resistance of the case and the resistance to the liquid fuel of the fuel storage chamber are ensured, and thus the fuel cartridge can be safely used for a long period.

Also, in the fuel cartridge for the fuel cell according to the present invention, an absorption member for absorbing the liquid fuel may be arranged between the fuel storage chamber and the case. Therefore, when the liquid fuel leaks from the inner container, the liquid fuel can be reliably absorbed by the absorption member. Therefore, the safety of the fuel cartridge can be improved still further.

Further, the fuel cartridge for the fuel cell may have a cover member for covering the pressure adjustment member, and the cover member may be formed like a sheet. Also, the fuel cartridge for the fuel according to the present invention has a cover member for covering a vent, and the cover member may be formed like a sheet. According to this arrangement, the liquid fuel can be prevented from leaking before the fuel cartridge is used.

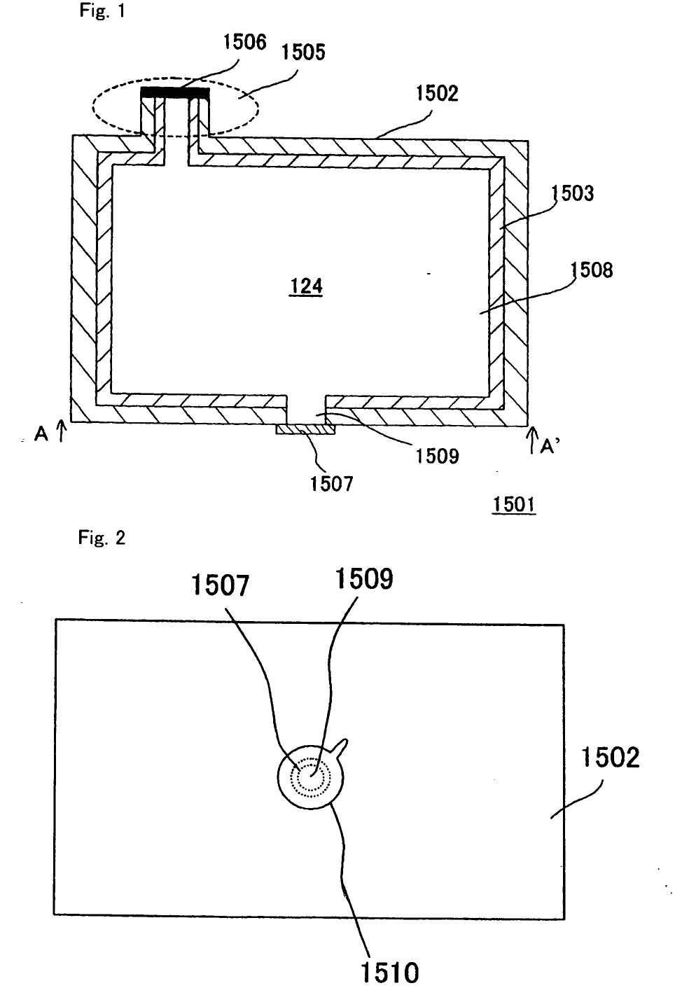

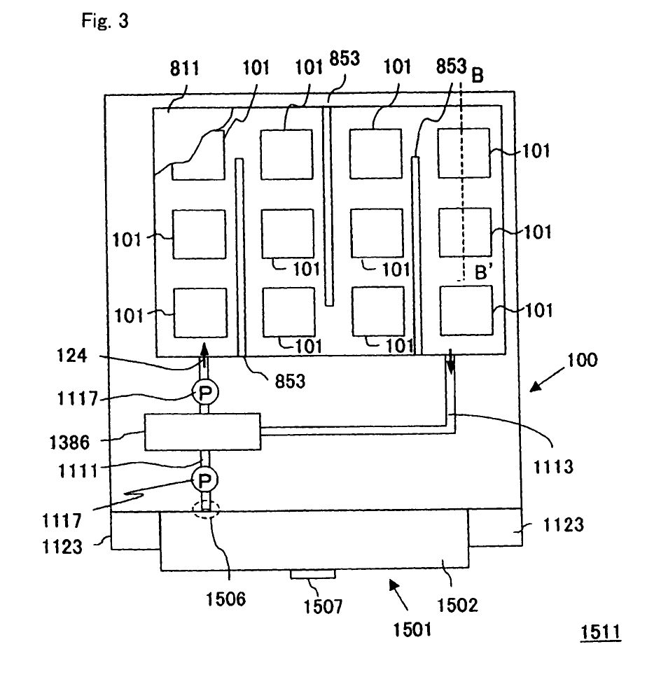

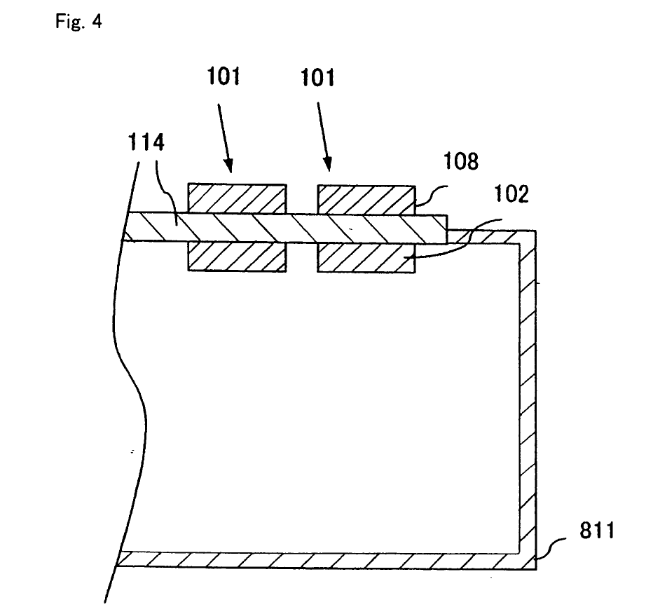

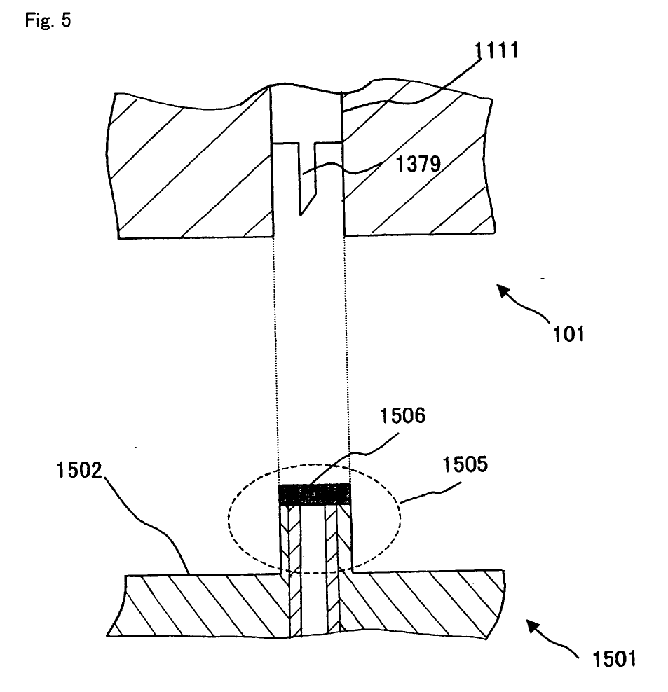

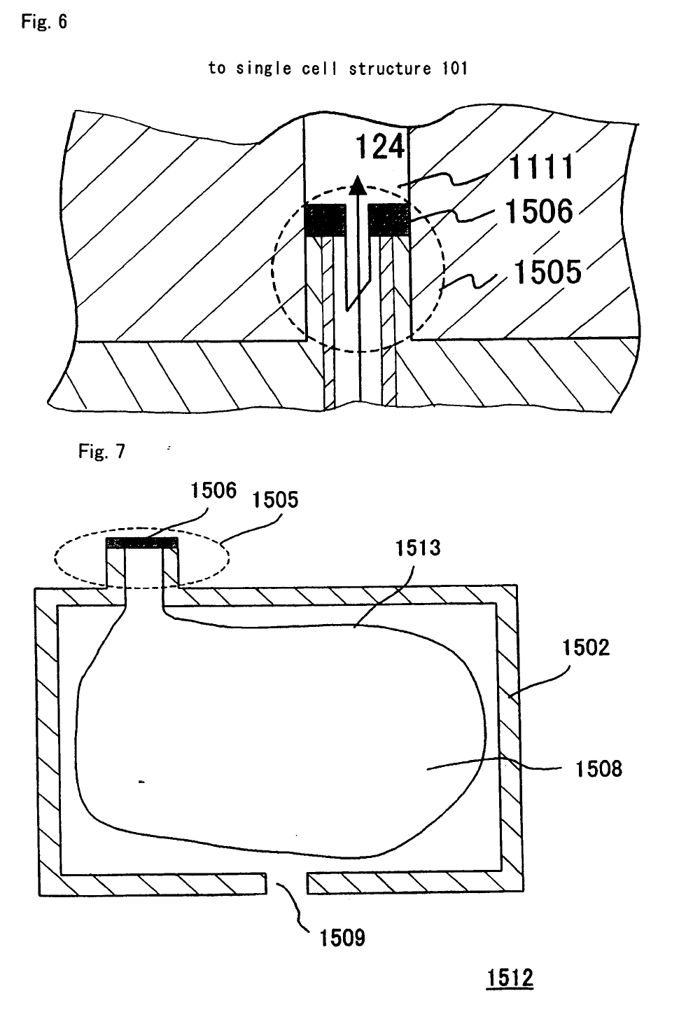

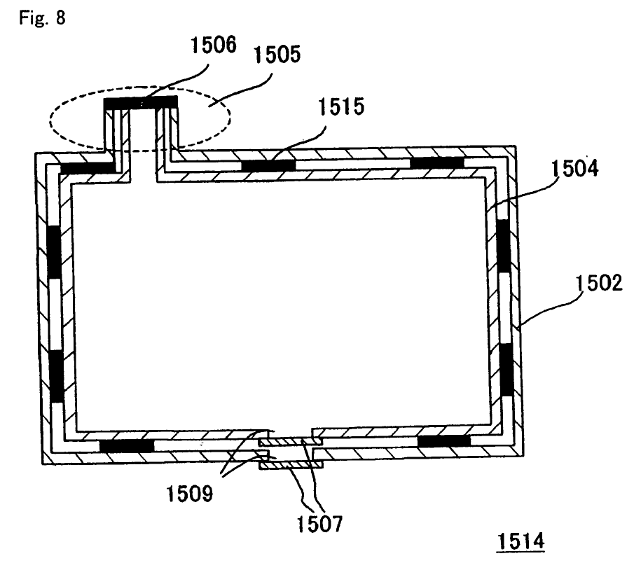

### BRIEF DESCRIPTION OF THE DRAWINGS

[FIG. 1] FIG. 1 is a cross-sectional view schematically showing an arrangement of a fuel cartridge according to the first embodiment of the present invention.

[FIG. 2] FIG. 2 is a drawing viewed in a direction indicated by arrows A, A′ in FIG. 1.

[FIG. 3] FIG. 3 is a plan view schematically showing an arrangement of a fuel cell according to the first embodiment of the present invention.

[FIG. 4] FIG. 4 is a cross-sectional view taken along line B-B′ in FIG. 3.

[FIG. 5] FIG. 5 is an enlarged view showing a connection portion between the fuel cartridge and the fuel cell main body according to the first embodiment of the present invention.

[FIG. 6] FIG. 6 is an enlarged view showing the connection portion between the fuel cartridge and the fuel cell main body according to the first embodiment of the present invention.

[FIG. 7] FIG. 7 is a cross-sectional view schematically showing an arrangement of a fuel cartridge according to the second embodiment of the present invention.

[FIG. 8] FIG. 8 is a cross-sectional view schematically showing an arrangement of a fuel cartridge according to the third embodiment of the present invention.

### BEST MODE FOR CARRYING OUT THE INVENTION

Hereinafter, explanations are given of embodiments according to the present invention with reference to drawings. Incidentally, the same reference numerals are applied to the same elements in all drawings and explanations thereof are omitted as appropriate.

The following embodiments relate to the fuel cartridge that is attachable and detachable to/from the fuel cell main body. The fuel cartridge can be replaced and can be carried. The fuel cell according to the following embodiments can be applied to a compact electronic device, such as a mobile phone, a portable personal computer of a notebook type and the like, PDA (Personal Digital Assistant), various cameras, a navigation system, and a portable music player.

### FIRST EMBODIMENT

FIG. 1 is a cross-sectional view showing an arrangement of the fuel cartridge according to the first embodiment of the present invention. Fuel cartridge 1501 shown in FIG.1 has a double structure including case 1502 and inner container 1503. Case 1502 and inner container 1503 are jointly integrated as a single member. Fuel 124 is stored in fuel chamber 1508 formed inside inner container 1503.

Fuel cartridge 1501 has injection part 1505, which is a part of the wall surface of case 1502 projecting to the outside of fuel cartridge 1501. At the end of injection part 1505, case 1502 and inner container 1503 are opened. Seal member 1506 seals this opening portion. Pressure adjustment port 1509 through case 1502 and inner container 1503 is formed at a predetermined position. Gas-liquid separation film 1507 that covers pressure adjustment port 1509 is arranged on the surface of case 1502.

Case 1502 is made of an impact-resistant material. As materials like this, for example, resin, such as polycarbonate (PC), polyacrylonitrile-butadiene -styrene (ABS), poly acryliete (PAR), acrylic modification polyvinyl chloride (KD), ultrahigh molecular weight polyethylene (UHMWPE), and glass-fiber-reinforced polyester (FRP), copolymer of two or more materials selected among these, and polymer alloy of two or more materials selected among these, may be mentioned. Case 1502 is made of the impact-resistant material, thereby sufficiently ensuring resistance to impact of fuel cartridge 1501 and improving the strength of fuel cartridge 1501.

The thickness of case 1502 is selected in accordance with materials, as appropriate. For example, the thickness of case 1502 may be 0.2 mm or more, preferably, 0.8 mm or more, thereby ensuring the impact-resistance characteristics of fuel cartridge 1501 sufficiently. On the other hand, as case 1502 is thinner, fuel cartridge 1501 can be reduced in weight. For example, the thickness of case 1502 may be 1.2 mm or less, preferably, 1 mm or less. As described above, when polycarbonate is used as the material of case 1502, case 1502 can be stably formed.

Inner container 1503 is made of a solvent-resistant material. The solvent-resistance means resistance to organic liquid fuel supplied to the fuel cell. The resistance means, for example, durability against dissolving and deterioration when in contact with the fuel component included in fuel 124. For example, when an alcohol solution, such as methanol, is used as fuel 124, inner container 1503 is made of a material that is resistant to dissolving and deterioration when in contact with alcohol. In the following, explanations are given of a case in that fuel 124 is alcohol or an alcohol solution, as an example.

As materials of inner container 1503, specifically, for example, resin, such as, polyethylene (PE), polypropylene (PP), polyvinyl chloride (PVC), polytetrafluoroethylene (PTFE), ethylene-trafluoroethylene copolymer (ETFE), polymethylpentene (TPX), ethylene vinyl acetate copolymer (EVA), polyurethane (PU), polyester like polyethylene terephthalate (PET), polyamide (PA) like nylon 6, and polyacetal (POM), copolymer of two or more materials that are selected among these, and polymer alloy of two or more materials that are selected among these may be mentioned.

The thickness of inner container 1503 may be 0.2 mm or more, preferably, 0.4 mm or more, thereby sufficiently ensuring resistance of the inner wall of fuel cartridge 1501 to fuel 124. On the other hand, as inner container 1503 is thinner, fuel cartridge 1501 can be reduced in weight. For example, the thickness of inner container 1503 may be 1 mm or less, preferably, 0.6 mm or less. Specifically, the thickness of inner container 1503 may be 0.5 mm. In this way, for example, when a polyethylene sheet is used, inner container 1503 having such thickness can be formed stably.

In fuel cartridge 1501, the materials that make up case 1502 and inner container 1503 may be a combination of materials, such as PC and PE, PC and PP, PC and PTFE, and the like. According to this arrangement, sufficient impact-resistance is given to case 1502 and sufficient solvent-resistance is given to inner container 1503.

Fuel cartridge 1501 according to this embodiment has a double structure in which inner container 1503 is joined to the inner wall of case 1502. Therefore, the impact-resistance of case 1502, which is apt to receive impact from the outside, can be higher than the impact-resistance of inner container 1503. Also, the solvent-resistance of inner container 1503 that is in contact with fuel 124 can be higher than the solvent-resistance of case 1502. According to this arrangement, the impact-resistance of fuel cartridge 1501 can be improved while the solvent-resistance of the inner wall in contact with fuel 124 is sufficiently ensured. Therefore, fuel cartridge 1501 whose safety characteristics are excellent can be stably obtained.

Incidentally, in the first embodiment, the solvent-resistance of resin can be evaluated, for example by visually observing the appearance of the material after it has been immersed in fuel 124 for a predetermined time and then removed. Also, the mechanical strength of the resin can be measured after it has been removed immersion in fuel 124.

Injection part 1505 projects toward the outside of fuel cartridge 1501. Therefore, injection part 1505 is fitted into and is connected with a fuel supply pipe of the fuel cell with reliability, as described later.

Also, seal member 1506 is arranged at the end of injection part 1505. Seal member 1506 is an elastic member having a self-sealing characteristic. Here, the self-sealing characteristic means the sealing characteristic between a pointed member such as a needle and a pieced member at the pierced portion thereof, when being pierced by the pointed member. A cover member is made of an elastic member, such as rubber, whereby the elastic member is elastically deformed when being pieced by a pointed member like a needle, and the pointed member and the pierced member are suitably sealed. As self-seal members, for example, septum made of silicon rubber or the like and re-seal made of ethylene propylene or the like can be mentioned. Additionally, vulcanized rubber may be used for a portion that is pierced by a pointed member. In this case, a slit may be arranged in the rubber, and a lubricant, such as silicon oil, may be applied to the side wall of the slit.

Seal member 1506 is preferably resistant to fuel 124. As materials like this, elastomer, such as ethylene-propylene rubber and silicone rubber can be used. When seal member 1506 is made of ethylene-propylene rubber, copolymer of ethylene and propylene (EPM) or copolymer of ethylene, propylene, and the third component (EPDM) may be used.

Gas-liquid separation film 1507 adheres to the external wall of case 1502 and covers pressure adjustment port 1509. Pressure adjustment port 1509 is covered with gas-liquid separation film 1507, thereby selectively allowing gas to flow through pressure adjustment port 1509. Therefore, fuel 124 stored in fuel chamber 1508 can be supplied to the fuel cell smoothly, and can be prevented from leaking to the outside of fuel cartridge 1501.

Gas-liquid separation film 1507 is made of a material whose surface tension relative to liquid fuel 124 is different from the surface tension relative to gas like air. Alternatively, a member having a construction in which the surface of a porous body is covered by a material like this may be used. Gas-liquid separation film 1507 may be formed by using a liquid-repellent material or the like. For example, when fuel 124 is methanol or an aqueous solution thereof, gas-liquid separation film 1507 is a film that prevents the methanol from permeating through the film.

As materials for gas-liquid separation film 1507, specifically, for example, perfluoropolymer such as polytetrafluoroethylene (also called “PTFE”) and tetrafluoroethylene-hexafluoropropylene copolymer (FEP), polyfluoroalkylacrylate such as polymethacrylic acid 1 H, 1 H-perfluorooctyl and polyacrylic acid 1H, 1H, 2H, 2H-perfluorodecile, and fluoroolefin such as polyvinyl fluoride and poly-fluorinated ethylene propylene, may be mentioned. Also, polyvinylidene chloride, polyacetal, copolymer resin of butadiene and acrylonitrile may be used.

Of these, perfluoropolymer like PTFE is preferably used, because of an excellent balance for selective gas permeability and film formation characteristics. Since gas-liquid separation film 1507 is necessary to efficiently permeate gas like air, film is required to be thin. Usually, gas-liquid separation film 1507 is desirably formed as a thin film of 5 μm or less, depending on the property of the film. When perfluoropolymer, like PTFE, is used, thin film like this can be formed stably.

Also, polyfluoroalkylacrylate-polymer, such as polymethacrylic acid 1H, 1H-perfluorooctyl and polyacrylic acid 1H, 1H, 2H, 2H-perfluorodecile, is excellent in film formation characteristics, is easy to form into a thin film, and has selective permeability to carbon dioxide, and therefore, is preferably used. Polyfluoroalkylacrylate-polymer can be obtained by esterifying a part or all of polycarboxylic acid with fluoroalcohol.

Polymer molecular weight of gas-liquid separation film 1507 is preferably from 1000 to 1,000,000 and is more preferably from 3000 to 100,000. When the molecular weight is too large, there is a possibility that solution preparation becomes difficult and it becomes difficult to make a restrictive permeation layer thin. When the molecular weight is too small, there may be a case in that no sufficient restrictive permeability cannot be obtained. Incidentally, in this description, the molecular weight is number average molecular weight and can be measured by GPC (Gel Permeation Chromatography).

Also, a gas-permeable and non-porous film may be laminated on a porous film to form gas-liquid separation film 1507. In this case, the above-mentioned film is used as a non-porous film. The porous film is a film made of, for example, polyether sulfone or acrylic copolymer. Specifically, Gore-Tex (registered trademark) manufactured by Japan Gore-Tex Co., Ltd, Versapor (registered trademark) manufactured by Nihon Pall Ltd, and Supor (registered trademark) manufactured by Nihon Pall Ltd are representative examples. The thickness of the porous film is set not less than 50 μm and not more than 500 μm. According to this arrangement, the mechanical strength of gas-liquid separation film 1507 can be improved. Therefore, fuel cartridge 1501 whose mechanical strength is excellent can be obtained stably.

Such a lamination film is formed by applying the above-mentioned polymer solution, which is a material made of non-porous film, on the surface of the porous film by the spin coat method and drying.

Incidentally, gas-liquid separation film 1507 may be arranged other ways than by having it adhere to the case. For example, a method may be adopted, in which gas-liquid separation film 1507 is held between case 1502 and a frame and is fixed to the outside of pressure adjustment port 1509 by a rivet or the like.

FIG. 2 is a drawing in the direction indicted by arrows A-A′. As shown in FIG. 2, in fuel cartridge 1501, peeling sheet 1510 covering gas-liquid separation film 1507 may be adhered to the external wall surface of case 1502 to be peelable.

Peeling sheet 1510 may be formed to be peelable from fuel cartridge 1501 when fuel cartridge 1501 is used. Emulsion adhesive like vinyl acetate, epoxy series adhesive, or silicon series adhesive is applied to the surface of the thin film that is made of various plastic materials. Also, in the arrangement shown in FIG. 2, a part of circular peeling sheet 1510 projects to the outside to form a peeling portion. The peeling portion is not adhered to case 1502, whereby peeling sheet 100 can be torn off easily from the peeling portion as a starting point when fuel cartridge 1501 is used.

Fuel cartridge 1501 may be manufactured, for example, by a method of forming a multilayer container, such as multilayer blow molding, like extrusion multilayer blow molding and injection multilayer blow molding. In fuel cartridge 1501, since case 1502 and inner container 1503 are joined, case 1502 and inner container 1503 can be manufactured at the same time according to such a method. Therefore, fuel cartridges that are excellent in manufacturing efficiency and manufacturing stability can be stably obtained. After forming case 1502 and inner container 1503, gas-liquid separation film 1507 and seal member 1506 are adhered to predetermined positions on the surface of case 1502, and then fuel cartridge 1501 can be obtained.

FIG. 3 is a view showing an arrangement of fuel cell 1511 to which fuel cartridge 1501 shown in FIG. 1 is attached. Fuel cell 1511 in FIG. 3 has fuel cell main body 100 and fuel cartridge 1501.

Fuel cell main body 100 includes a plurality of single cell structures 101, fuel container 811, partition plate 853, fuel flow pipe 1111, fuel recovery pipe 1113, reservoir tank 1386, pump 1117, and connector 1123. Fuel cartridge 1501 is attachable and detachable to/from fuel cell main body 100 by connector 1123. Also, not shown, fuel cell main body 100 has an oxidizer electrode side effluent recovery pipe that is used to recover water generated by the cell reaction at the oxidizer electrode of single cell structure 101 into reservoir tank 1386.

In this arrangement, liquid fuel 124 stored in fuel cartridge 1501 is supplied to single cell structure 101. Pump 1117 is arranged in fuel flow pipe 1111, and fuel flow pipe 1111 is connected to fuel container 811 through reservoir tank 1386. Therefore, fuel 124 is supplied to fuel container 811 through fuel flow pipe 1111. Fuel 124 that flowed into fuel container 811 flows along the plurality of partition plates 853 arranged in fuel container 811 and is sequentially supplied to the plurality of single cell structures 101. The portion of fuel 124 that is supplied to single cell structure 101 and that is not used for the cell reaction, is recovered in reservoir tank 1386 from fuel recovery pipe 1113. Recovered fuel is mixed with water recovered from the oxidizer electrode side effluent recovery pipe (not shown) in reservoir tank 1386, and is once again supplied from fuel flow pipe 1111 to fuel container 811.

As pump 1117, for example, a piezoelectric element, such as a compact piezoelectric motor with lower power consumption, can be used. Also, not shown in FIG. 3, fuel cell 1511 may be provided with a control section for adjusting the operation of pump 1117 to control the supply of fuel 124 to single cell structure 101.

FIG. 4 is a cross-sectional view taken along line B-B′in FIG. 3. Single cell structure 101 includes fuel electrode 102, oxidizer electrode 108, and solid electrolyte film 114. In the fuel cell in FIG. 4, a plurality of fuel electrodes 102 are arranged on one surface of one solid electrolyte film 114, and a plurality of oxidizer electrodes 108 are arranged on another surface. The plurality of single cell structures 101 share solid electrolyte film 114 and are arranged in the same plane. Also, fuel container 811 is arranged to cover and surround the outside of fuel electrode 102, and the liquid fuel stored in or supplied to fuel container 811 is directly supplied to fuel electrode 102.

Solid electrolyte film 114 separates fuel electrode 102 and oxidizer electrode 108 and acts to move hydrogen ions therebetween. Therefore, preferably, solid electrolyte film 114 is a film having a high conductivity for hydrogen ions. Also, preferably, solid electrolyte film 114 is chemically suitable and mechanically strong. As a material to form solid electrolyte film 114, organic polymer having a polar group, such as a strong acid group, like sulfone group and phosphate group, or a weak acid group, like carboxyl group, is preferably used. As an organic polymer like this, sulfonated poly (4-phenoxy benzoyl-1, 4-phenylene), aromatic series condensed polymer, such as alkyl sulfonic poly benzimidazole; sulfone-base-containing perfluorocompounds (Nafion (manufactured by Dupont CO., LTD: registered mark) and Aciplex (manufactured by Asahi KASEI CO., LTD: registered mark), or carboxyl-base-containing perfluorocompounds (Flemion S fim (manufactured by Asahi GLASS CO., LTD) are mentioned as examples.

Each of fuel electrode 102 and oxidizer electrode 108 may be provided by forming a fuel electrode side catalyst layer and an oxidizer electrode side catalyst layer including carbon particles supporting catalyst and solid electrolyte particles on each substrate.

As catalysts for the fuel electrode side catalyst layer, platinum, gold, silver, ruthenium, rhodium, palladium, osmium, iridium, cobalt, nickel, rhenium, lithium, lanthanum, strontium, yttrium, and alloys thereof are mentioned as examples. As catalysts for the oxidizer electrode side catalyst layer used in oxidizer electrode 108, the same catalysts as in the fuel electrode side catalyst layer can be used, and the above-mentioned substances can be used. Incidentally, the same catalyst or different catalysts may be used for the fuel electrode side catalyst layer and the oxidizer electrode side catalyst layer.

As bases of both fuel electrode 102 and oxidizer electrode 108, a porous substrate, such as a carbon paper, a carbon compound, a carbon sintered compound, sintered metal, and foam metal, may be used.

In fuel cell main body 100 arranged in this way, fuel 124 is supplied to fuel electrode 102 in each cell structure 101 from fuel cartridge 1501. Also, oxidizer is supplied to oxidizer electrode 108 in each cell structure 101. As fuel 124 stored in fuel cartridge 1501, methanol, ethanol, dimethyl ether, or other alcohols, may be used. When liquid fuel is used, aqueous solutions thereof can be used. As the oxidizer, usually, air can be used, however, oxygen gas may be supplied.

Next, explanations are given of how to use fuel cartridge 1501. Fuel cartridge 1501 prior to use is filled with liquid fuel 124, and injection part 1505 is sealed by seal member 1506. Also, gas-liquid separation film 1507 is covered by peeling sheet 1510.

When fuel cartridge 1501 is used, fuel cartridge 1501 is attached to connector 1123 of fuel cell main body 100. At this time, injection part 1505 of fuel cartridge 1501 is inserted and fitted in fuel flow pipe 1111.

FIGS. 5 and 6 are enlarged views showing a connection portion between fuel cartridge 1501 and fuel flow pipe 1111 in FIG. 3. FIG. 5 shows a state in which fuel cell main body 100 and fuel cartridge 1501 are separated. FIG. 6 shows a state in which they are connected. As shown in FIGS. 5 and 6, hollow needle 1379 is arranged at the tip of fuel flow pipe 1111 in fuel cell main body 100. When fuel cartridge 1501 is attached to fuel cell main body 100, hollow needle 1379 penetrates seal member 1506. Therefore, the liquid fuel in fuel cartridge 1501 is fed to fuel flow pipe 1111. Since this fuel flow pipe 1111 is connected to fuel electrode 102 in single cell structure 101, as described above, fuel 124 is supplied to fuel electrode 102.

Incidentally, since seal member 1506 has a self-sealing characteristic, seal member 1506 is in intimate contact with the periphery of hollow needle 1379 when being pierced with hollow needle 1379, and hermeticity is ensured. Therefore, liquid fuel can be suitably prevented from leaking. Also, when hollow needle 1379 is removed, the hole is sealed and hermeticity is ensured.

Also, hollow needle 1379 is stored in fuel flow pipe 1111 in fuel cell main body 100. Therefore, though fuel cartridge 1501 is removed, hollow needle 1379 does not project from the wall surface of fuel cell main body 100, and the user can attach and detach fuel cartridge 1501 safely.

Incidentally, in fuel cell 1511, fuel cartridge 1501 and fuel flow pipe 1111 are connected by another arrangement other than seal member 1506 and hollow needle 1379. A coupler, like a nut coupler, is arranged at the tip of fuel flow pipe 1111 or injection part 1505 of fuel cartridge 1501, and fuel cartridge 1501 and fuel flow pipe 111 may be connected by the coupler.

Also, in fuel cell 1511, an exhaust fan is arranged instead of the oxidizer electrode side effluent recovery pipe (not shown), and the moisture and the gas generated by the reaction in fuel cell main body 100 may be exhausted from an exhaust port to the outside of the cell.

### SECOND EMBODIMENT

FIG. 7 is a cross-sectional view schematically showing a fuel cartridge according to the second embodiment of the present invention. The principle arrangement of fuel cartridge 1512 shown in FIG. 7 is similar to that of fuel cartridge 1501 shown in FIG. 1, however, they are different in the arrangement of inner container 1513 that is made of the same material as inner container 1503 in case 1502. Case 1502 and inner container 1513 are joined at injection part 1505. Also, case 1502 is provided with pressure adjustment port 1509, similar to the first embodiment, however, no gas-liquid separation film 1507 may be arranged, as shown in FIG. 7.

Inner container 1513 according to the second embodiment is formed, for example, by flexible or strong stretchy resin. When pump 1117 for supplying fuel 124 stored in the fuel cartridge to single cell structure 101 is arranged, like fuel cell 1511 in FIG. 3, inner container 1513 may be flexible resin and may not be an elastic member. As resin materials of inner container 1513, specifically, the materials mentioned as examples for inner container 1503 in the first embodiment may be mentioned. For example, inner container 1503 may be polyethylene, polypropylene, or the like in a bag shape.

The thickness of inner container 1513 is selected in accordance with the constituent material thereof, as appropriate, and, for example, may be set to 50 μm or more, preferably, 100 μm or more, thereby sufficiently ensuring the mechanical strength of inner container 1513. Also, when inner container 1513 is thinner, fuel cartridge 1512 can be reduced in weight and can be improved in flexibility in shape. For example, the thickness of inner container 1513 is set to 300 μm or less, preferably, 200 μm or less. For example, if polyethylene and polypropylene are used as materials, inner container 1513 can be formed stably.

Fuel cartridge 1512, for example, is manufactured as follows. First, case 1502 is manufactured. When case 1502 is made of resin, a method that is usually used to manufacture a resin container, such as injection molding, blow molding, or the like can be selected, as appropriate. Inner container 1513 that is separately manufactured by blow molding or the like is inserted into obtained case 1502, and they are joined at injection part 1505.

Also, a method of forming case 1502 as two separate parts may be used. In this case, inner container 1513 is stored in two parts to form case 1502, after which each of the end surfaces of the two parts is joined. As methods for joining the surfaces, joining by ultrasound, heating, adhesives, or the like may be selected, as appropriate. Also, a concave portion is arranged in one junction surface of two parts, a convex portion is arranged in another part, and they may be connected. In this way, inner container 1513 is stored in case 1502.

When the double structure of inner container 1513 and case 1502 is obtained, seal member 1506 is adhered to the end surface of injection part 1505. In this way, fuel cartridge 1512 is obtained. Incidentally, when gas-liquid separation film 1507 that covers pressure adjustment port 1509 of case 1502 is arranged, it may be adhered to the case.

Because case 1502 is made of material that has excellent impact-resistance characteristics, an arrangement in which fuel cartridge 1512 has excellent impact-resistance properties can be stably obtained. Also, inner container 1513 is arranged in the case and the inside of inner container 1513 is fuel chamber 1508. Since inner container 1513 is made of material whose solvent-resistance is excellent, dissolution and deterioration of inner container 1513 which is caused by fuel 124 stored in fuel chamber 1508 are suitably prevented. Therefore, fuel cartridge 1512 also has excellent solvent-resistance. In this way, according to the double structure of case 1502 and inner container 1513, impact-resistance and solvent-resistance can be improved in fuel cartridge 1512. Also, since inner container 1513 is flexible, the inner volume thereof can be changed in accordance with the amount of fuel stored inside.

When fuel cartridge 1512 is used, flexible inner container 1513 is deflated in accordance with the consumption of fuel 124 and the volume thereof is reduced. At this time, air passes through gas-liquid separation film 1507 to the inside of case 1502, and inner container 1513 is compressed. Therefore, negative pressure is prevented from forming inside of case 1502. Accordingly, in the arrangement of fuel cartridge 1512, injection part 1505 can be connected to fuel cell main body 100, and fuel 124 can be stably supplied to single cell structure 101.

Incidentally, in fuel cartridge 1512, the peeling sheet that covers pressure adjustment port 1509 may be adhered to the external wall surface of case 1502 to be peelable. According to this arrangement, pressure adjustment port 1509 can be reliably sealed until fuel cartridge 1512 is used. Therefore, leakage of fuel 124 from inner container 1503 can be prevented. Therefore, the safety of the fuel cartridge can be improved still further. As materials of the peeling sheet, the same material may be used as peeling sheet 1510 (see FIG. 2) that covers gas-liquid separation film 1507 in the first embodiment.

### THIRD EMBODIMENT

FIG. 8 is a cross-sectional view schematically showing the arrangement of the fuel cartridge according to the third embodiment of the present invention. The principle arrangement of fuel cartridge 1514 shown in FIG. 8 is similar to that of fuel cartridge 1501 shown in FIG. 1, however, they are different in that cushioning member 1515 is arranged between case 1502 and inner container 1504. Also, each pressure adjustment port 1509 that is formed in case 1502 and inner container 1504 is covered with gas-liquid separation film 1507.

As materials of case 1502 and inner container 1504, for example, the same materials as in the first embodiment may be used. Also, inner container 1504 may be made of materials that have no flexibility or no strong stretching property and may be made of materials that have these properties. When inner container 1504 is made of materials that have flexibility or a strong stretching property, for example, inner container 1504 may be made of the materials, mentioned as examples in the second embodiment.

Also, cushioning member 1515 is a member that is arranged between inner container 1504 and case 1502 and supports them. Cushioning member 1515 may be made of elastic materials, such as foamed resin materials, rubber, and gelatinous resin materials. Cushioning member 1515 is preferably made of materials having excellent resistance to fuel 124.

As materials of cushioning member 1515, specifically, for example, the following may be used:

diene series rubber, such as natural rubber (NR), isoprene rubber (IR), butadiene rubber (BR), styrene-butadiene rubber (SBR), chloroprene rubber (CR), and acrylonitrilebutadiene rubber (NBR);

non diene series rubber, such as silicone rubber (Q), like vinyl methyl silicone rubber (VMQ) and fluorinated silicone rubber (FVMQ), isobutene-isoprene copolymer (butyl rubber: IIR), like low hardness isobutene isoprene rubber, urethane rubber (U), and ethylene propylene rubber (EPM, EPDM);

ethylene-vinyl acetate copolymer (EVA);

foam resin material, such as foam of the above-mentioned elastic materials;

gelatinous resin materials, such as silicon gel and styrene gel including hydrogenated styrene block copolymer, like styrene ethylene-propylene styrene block copolymer (SEPS) and styrene ethylene butylenes styrene block copolymer (SEBS), and flexibilizer, like paraffin.

When cushioning member 1515 is silicon series gel, for example, a GEL (registered trademark) manufactured by GELTEC CO., Ltd. may be used. Also, when cushioning member 1515 is styrene series gel, for example, KG-GEL (trademark) manufactured by KITAGAWA INDUSTRIES CO., Ltd. may be used

Also, cushioning member 1515 may be a sheet-shaped member or the like. According to this arrangement, fuel cartridge 1514 is reduced in size and the impact-resistance thereof can be sufficiently improved.

Fuel cartridge 1514 is manufactured as follows, as an example. First, inner container 1504 is manufactured. Inner container 1504 may be manufactured by selecting a method among the methods that are usually used to form a resin container, in accordance with the material and the shape thereof. Pressure adjustment port 1509 is arranged in inner container 1504, and gas-liquid separation film 1507 that covers it is adhered. Also, sheet-shaped cushioning member 1515 is adhered to the external surface of inner container 1504.

On the other hand, case 1502 is formed separately. In this case, for example, case 1502 is formed as two separate parts, as explained in the second embodiment. Inner container 1504 to which cushioning member 1515 is adhered is stored in two parts that form case 1502, and then both end faces of these two parts are joined. In this way, cushioning member 1515 and inner container 1504 are sequentially stored in case 1502.

After that, gas-liquid separation film 1507 and seal member 1506 are arranged, similar to the first or second embodiment, whereby fuel cartridge 1514 can be obtained.

Incidentally, cushioning member 1515 is adhered to inner container 1504 in the third embodiment, however, cushioning member 1515 may be adhered to case 1502. Also, cushioning member 1515 may be joined to either case 1502 or inner container 1504. In particular, when the material of inner container 1504 is flexible or is made of strong stretch resin, cushioning member 1515 is adhered to either case 1502 or inner container 1504, thereby surely changing the shape of inner container 1504.

Since fuel cartridge 1514 also has the double structure of case 1502 and inner container 1504, impact-resistance and the solvent-resistance can be improved. Further, in fuel cartridge 1514, cushioning member 1515 is arranged between case 1502 and inner container 1505, and thus impact from the outside can be absorbed by cushioning member 1515. Also, when the fuel cartridge suffers an impact, such as in a fall, while the fuel cartridge is connected to fuel cell main body 100 and while in use, the weight is concentrated at injection part 1505 in the arrangement in which there is no cushioning member 1515. However, in the third embodiment, since cushioning member 1515 is arranged between case 1502 and inner container 1504, the weight can be shared by entire fuel cartridge 1514.

As described above, cushioning member 1515 is arranged, thereby improving the impact-resistance of fuel cartridge 1514 and enhancing the mechanical strength. Therefore, deterioration, breakage, and the like of fuel cartridge 1514 can be reliably prevented.

Also, in comparison with the arrangement in which case 1502 and inner container 1504 directly adhere to the overall surface, the arrangement provided with cushioning member 1515 can suitably prevent deterioration caused by differences in heat shrink efficiencies between these materials.

Incidentally, in the arrangement shown in FIG. 8, cushioning members 1515 partially fill into a space between case 1502 and inner container 1504. However, a space between case 1502 and inner container 1504 may be entirely filled with cushioning member 1515.

Also, in the arrangement in which cushioning members 1515 are partially fill the space, the space may be filled with a fuel absorption member for absorbing fuel 124. The fuel absorption member is filled, whereby fuel 124 can be reliably absorbed when fuel 114 leaks from inner container 1503. Therefore, the safety of fuel cartridge 1514 can be further improved. As materials of the fuel absorption member, for example, water-absorbing polymer may be used. For example, sodium polyacrylate series like sodium salt polyacrylate, acrylamide series like polyacrylamide, poly N-vinyl acetamide, poly N-vinyl formamide, polyvinyl alcohol, polyethylene oxide, polyethylene glycol, poly N-vinyl pyrrolidone, cross-linked acrylic copolymer, polyester, agar, gelatin, starch, styrene-divinylbenzene series, polyglutamic acid, polyacrylic acid, and vinyl acetate acrylic, and copolymer or mixture thereof may be mentioned as examples. An absorbing-water polymer may be selected from materials that are resistant to fuel 124.

As described above, the present invention is explained with reference to the embodiments. These embodiments are examples, and a person skilled in the art will understand that combinations of each element and each process may be modified and such examples may be within the scope of the present invention.

For example, in each above-mentioned embodiment, explanations are given of the case in which case 1502 is the outermost layer of the fuel cartridge as an example. However, such as a member for wrapping case 1502 internally may be arranged at the outside of case 1502.

Also, in the above-mentioned embodiments, explanations are given of the case in which an alcohol solution is stored in the fuel cartridge, as an example. However, liquid fuel, such as liquid hydrocarbon like cycloparaffin, formalin, formic acidor, or hydrazine, may be stored in the fuel cartridge and may be used. Also, alkali may be added to the liquid fuel. According to this arrangement, the ion conductivity of hydrogen ion can be improved.

1. A fuel cartridge for a fuel cell, that is stored with liquid fuel to be supplied to a fuel electrode in the fuel cell and that is attachable and detachable to/from said fuel cell, is characterized in that the fuel cartridge comprises:
a fuel storage chamber whose an inner surface is made of resin that is resistant to said liquid fuel;
a case that contains said fuel storage chamber internally and that is made of impact-resistant resin; and
a fuel supply part that is connected to said fuel storage chamber and that supplies said liquid fuel to said fuel cell.

2. The fuel cartridge for the fuel cell according to claim 1 is characterized in that said inner surface of said fuel storage chamber is made of alcohol-resistant resin.

3. The fuel cartridge for the fuel cell according to claim 1 or 2 is characterized in that said fuel storage chamber is made of a bag-shaped member that is made of a flexible resin material.

4. The fuel cartridge for the fuel cell according to claim 1 or 2 is characterized in that said fuel storage chamber and said case are jointly integrated.

5. The fuel cartridge for the fuel cell according to claim 1 or 2 is characterized in that a cushioning member is arranged between said fuel storage chamber and said case.

6. The fuel cartridge for the fuel cell according to claim 5 is characterized in that said cushioning member includes one material or two or more materials from among natural rubber, isoprene rubber, butadiene rubber, styrene-butadiene rubber, chloroprene rubber, acrylonitrilebutadiene rubber, silicone rubber, butyl rubber, urethane rubber, ethylene propylene rubber, ethylene-vinyl acetate copolymer, foamed polyurethane, silicone gel, and styrene gel.

7. The fuel cartridge for the fuel cell according to claim 1 or 2 is characterized in that the fuel cartridge comprises a pressure adjustment member for adjusting an inner pressure of said fuel storage chamber.

8. The fuel cartridge for the fuel cell according to claim 7 is characterized in that said pressure adjustment member includes a gas-liquid separation film.

9. The fuel cartridge for the fuel cell according to claim 1 or 2 is characterized in that the fuel cartridge comprises a vent that passes through said case.

10. A fuel cell is characterized in that the fuel cell comprises a fuel cell main body having a fuel electrode and a fuel cartridge for the fuel cell according to claim 1 or 2, which is stored with liquid fuel to be directly supplied to said fuel electrode.
